(19) United States
(12) Patent Application Publication
(10) Pub. No.: US 2026/0229990 A1
(43) Pub. Date: Aug. 6, 2026

(54) SWITCHING CONTROL CIRCUIT AND POWER SUPPLY CIRCUIT

(71) Applicant: FUJI ELECTRIC CO., LTD., Kawasaki-shi (JP)

(72) Inventor: Ryuji YAMADA, Tokyo (JP)

(73) Assignee: FUJI ELECTRIC CO., LTD., Kawasaki-shi (JP)

(21) Appl. No.: 19/402,782

(22) Filed: Nov. 26, 2025

(30) Foreign Application Priority Data
Jan. 31, 2025 (JP) 2025-015104

(51) Int. Cl. H02M 1/42; H02M 1/08; H02M 7/217

(52) U.S. Cl. CPC H02M 1/42; H02M 1/08; H02M 7/217

(57) ABSTRACT

A switching control circuit for a power supply circuit including an inductor, a first transistor controlling an inductor current , and a second transistor therebetween. The switching control circuit complementarily switches the first and second transistors, and includes: a time period output circuit outputting a first time period with the first transistor being off and the second transistor being on; and a drive signal output circuit outputting first and second drive signals to respectively switch the first and second transistors. The drive signal output circuit outputs the second drive signal to turn off the second transistor, in response to the first time period having elapsed since the inductor current has reached a predetermined value with the first transistor being off, and outputs the first drive signal to turn on the first transistor, in response to a second time period having elapsed after the lapse of the first time period.

### CROSS-REFERENCE TO RELATED APPLICATION

This application claims priority pursuant to 35 U.S.C. §119 from Japanese Patent Application No. 2025-015104, filed on January 31, 2025, of which is incorporated herein by reference.

### BACKGROUND

### Technical Field

The present invention relates to a switching control circuit and a power supply circuit.

### Related Art

Some power factor correction circuits are designed to operate in critical mode to turn on a transistor once an inductor current reaches a predetermined value (e.g., zero) (see, for example, Japanese Patent Nos. 7501267 and 6911677, Japanese Patent Application Publication No. 2022-096152, and International Publication Nos. WO2023/048074 and WO2023/105896).

However, in a power factor correction circuit that operates in critical mode, it is difficult to turn on a transistor when a voltage between the drain and source of the transistor reaches zero, to reduce switching loss.

### SUMMARY

An aspect of the present disclosure is a switching control circuit for a switching control circuit for a power supply circuit that generates, for an output capacitor, an output voltage at a target level from an alternating current (AC) voltage inputted to the power supply circuit, the power supply circuit including an inductor configured to receive a rectified voltage corresponding to the AC voltage, a first transistor configured to control an inductor current flowing through the inductor, the first transistor having a parasitic capacitor , and a second transistor provided between the inductor and the output capacitor, the switching control circuit being configured to complementarily switch the first transistor and the second transistor, the switching control circuit comprising: a time period output circuit configured to output a first time period in which the inductor current changes from a predetermined value to a first value smaller than the predetermined value, with the first transistor being off and the second transistor being on; and a drive signal output circuit configured to output a first drive signal to switch the first transistor and a second drive signal to switch the second transistor, the drive signal output circuit being configured to output the second drive signal to turn off the second transistor, in response to the first time period having elapsed since the inductor current has reached the predetermined value with the first transistor being off, and output the first drive signal to turn on the first transistor, in response to a second time period having elapsed after the lapse of the first time period, and the second time period being determined based on a resonant period of the parasitic capacitor of the first transistor and the inductor, and being a time period in which a voltage level of an output electrode of the first transistor drops to a predetermined level.

An aspect of the present disclosure is a power supply circuit configured to generate, for an output capacitor, an output voltage at a target level from an alternating current (AC) voltage inputted to the power supply circuit, the power supply circuit comprising: an inductor configured to receive a rectified voltage corresponding to the AC voltage; a first transistor configured to control an inductor current flowing through the inductor, the first transistor having a parasitic capacitor; a second transistor provided between the inductor and the output capacitor; and a switching control circuit configured to complementarily switch the first transistor and the second transistor, the switching control circuit including a time period output circuit configured to output a first time period from when the inductor current changes from a predetermined value to a first value smaller than the predetermined value, with the first transistor off and the second transistor on, and a drive signal output circuit configured to output a first drive signal to switch the first transistor, and a second drive signal to switch the second transistor, the drive signal output circuit being configured to output the second drive signal to turn off the second transistor, in response to the first time period having elapsed since the inductor current has reached the predetermined value with the first transistor being off, and output the first drive signal to turn on the first transistor, in response to a second time period having elapsed after the lapse of the first time period, and the second time period being determined based on a resonant period of the parasitic capacitor of the first transistor and the inductor, and being a period in which a voltage level of an output electrode of the first transistor drops to a predetermined level.

### BRIEF DESCRIPTION OF THE DRAWINGS

FIG. 1 is a diagram illustrating an example configuration of an AC-DC converter 10.

FIG. 2 is a diagram illustrating an example configuration of a power factor correction IC 25a.

FIG. 3 is a diagram illustrating an example configuration of a digital circuit 100.

FIG. 4 is a diagram illustrating an example operation of the power factor correction IC 25a.

FIG. 5 is a diagram illustrating a path in which an inductor current IL flows in a time period P1.

FIG. 6 is a diagram illustrating a path in which the inductor current IL flows in a time period P2.

FIG. 7 is a diagram illustrating a path in which the inductor current IL flows in a time period Px.

FIG. 8 is a diagram illustrating example simulation results.

FIG. 9 is a diagram illustrating an example configuration of an AC-DC converter 12.

FIG. 10 is a diagram illustrating an example configuration of a power factor correction IC 25b.

FIG. 11 is a diagram illustrating an example configuration of a digital circuit 110.

FIG. 12 is a diagram illustrating an example embodiment using a DSP.

### DETAILED DESCRIPTION

At least the following matters are disclosed by this specification and the drawings attached hereto. Hereinafter, identical or equivalent components, members, and the like illustrated in the drawings are denoted by the same reference numerals, and a repeated description thereof may be omitted as appropriate.

### Present Embodiment

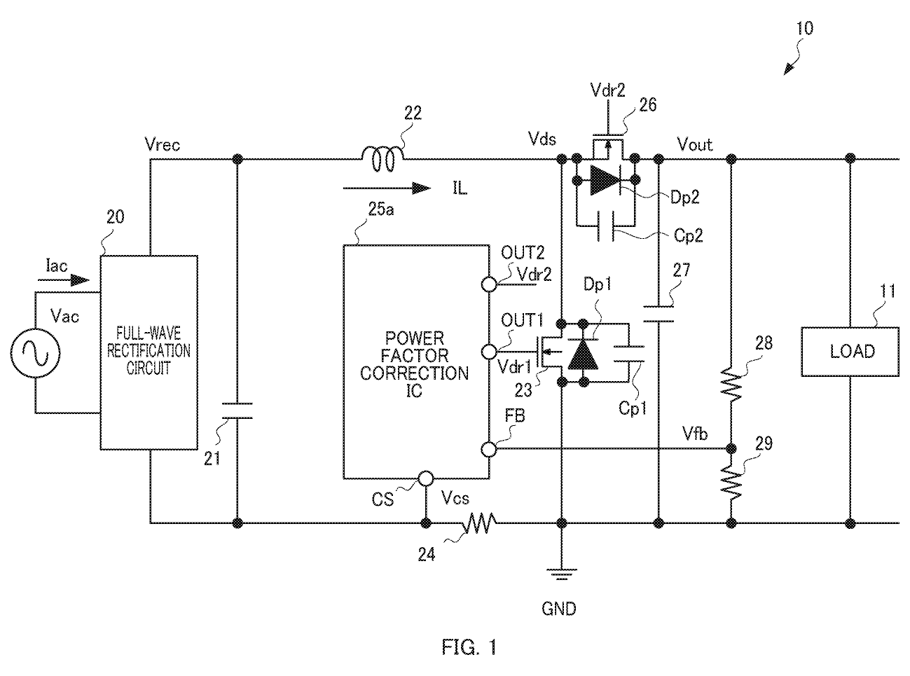

FIG. 1 is a diagram illustrating an example configuration of an AC-DC converter 10 according to an embodiment of the present invention. The AC-DC converter 10 is a boost chopper power supply circuit configured to generate an output voltage Vout at a target level of an AC voltage Vac from a commercial power supply. The AC-DC converter 10 applies the output voltage Vout to a load 11 and supplies power. As will be described in detail later, the AC-DC converter 10 includes an NMOS transistor 23 (described later) and a synchronous rectification NMOS transistor 26 and operates as a power factor correction circuit that operates in critical mode. "Critical mode" is a mode where a transistor is switched on after an inductor current IL described later reaches zero.

The AC-DC converter 10 includes a full-wave rectifier circuit 20, capacitors 21 and 27, an inductor 22, the NMOS transistors 23 and 26, resistors 24, 28, and 29, and a power factor correction IC 25a.

The full-wave rectifier circuit 20 full-wave rectifies an inputted predetermined AC voltage Vac and then applies the rectified voltage to the capacitor 21 and the inductor 22 as an input voltage Vrec. The AC voltage Vac is a voltage with, for example, an effective value of 140 V to 240V and a frequency of 50 Hz to 60 Hz. Although a voltage basically refers to a potential difference from a reference point (GND in FIG. 1) in the present embodiment below, the AC voltage Vac is a volage between terminals. The full-wave rectifier circuit 20 is formed by a diode bridge that is not shown. Current from the commercial power supply is referred to as an input current Iac.

The capacitor 21 smooths the input voltage Vrec, and the capacitor 27 configures a boost chopper circuit together with the inductor 22 and the NMOS transistors 23 and 26. Thus, a charging voltage of the capacitor 27 is a DC output voltage Vout. The capacitor 27 corresponds to the "output capacitor."

The NMOS transistor 23 is a switching device configured to control the inductor current flowing through the inductor 22 and control power of the AC-DC converter 10 to the load 11. Although the NMOS transistor 23 is an N-type metal oxide semiconductor (NMOS) transistor in the present embodiment, it is to be noted that the NMOS transistor 23 may be, for example, a bipolar transistor or the like.

The gate electrode of the NMOS transistor 23 is coupled to a terminal OUT1 of the power factor correction IC 25a. Further, the NMOS transistor 23 has a parasitic diode Dp1 and a parasitic capacitor Cp1. The NMOS transistor 23 corresponds to the "first transistor," and the drain electrode of the NMOS transistor 23 corresponds to the "output electrode."

The resistor 24 is a resistor for detecting the inductor current IL flowing through the inductor 22 when the NMOS transistor 23 is turned on and has one end coupled to the source electrode of the NMOS transistor 23 and the other end coupled to a terminal CS of the power factor correction IC 25a.

Note that the inductor current IL flowing in the direction indicated by the arrow in FIG. 1 is referred to as the inductor current IL flowing in a positive direction, and the inductor current IL flowing in a direction opposite from the arrow is referred to as the inductor current IL flowing in a negative direction.

The power factor correction IC 25a is an integrated circuit configured to complementarily switch the NMOS transistor 23 and the synchronous rectification NMOS transistor 26 in order to achieve an output voltage Vout at a target level (e.g., 400 V) while correcting the power factor of the AC-DC converter 10. Specifically, the power factor correction IC 25a drives the NMOS transistor 23 based on the inductor current IL and the output voltage Vout. As will be described in detail later, the power factor correction IC 25a is provided with the terminals CS, FB, OUT1, and OUT2. Note that terminals other than the terminal CS and the like of the power factor correction IC 25a are omitted in the present embodiment for convenience.

The NMOS transistor 26, which is a synchronous rectification transistor, is provided between the inductor 22 and the capacitor 27 and is switched complementarily with the NMOS transistor 23. The gate electrode of the NMOS transistor 26 is coupled to the terminal OUT2 of the power factor correction IC 25a. Further, as will be described in detail later, the NMOS transistor 26 is turned on when the NMOS transistor 23 is turned off, so as to pass the inductor current IL from the inductor 22 to the capacitor 27. The NMOS transistor 26 has a parasitic diode Dp2 and a parasitic capacitor Cp2. The NMOS transistor 26 corresponds to the "second transistor."

The resistors 28 and 29 configure a voltage divider circuit configured to divide the output voltage Vout and generate a feedback voltage Vfb used in switching of the NMOS transistor 23. The feedback voltage Vfb generated at the node of connection between the resistors 28 and 29 is applied to the terminal FB.

### Configuration of the Power Factor Correction IC 25a

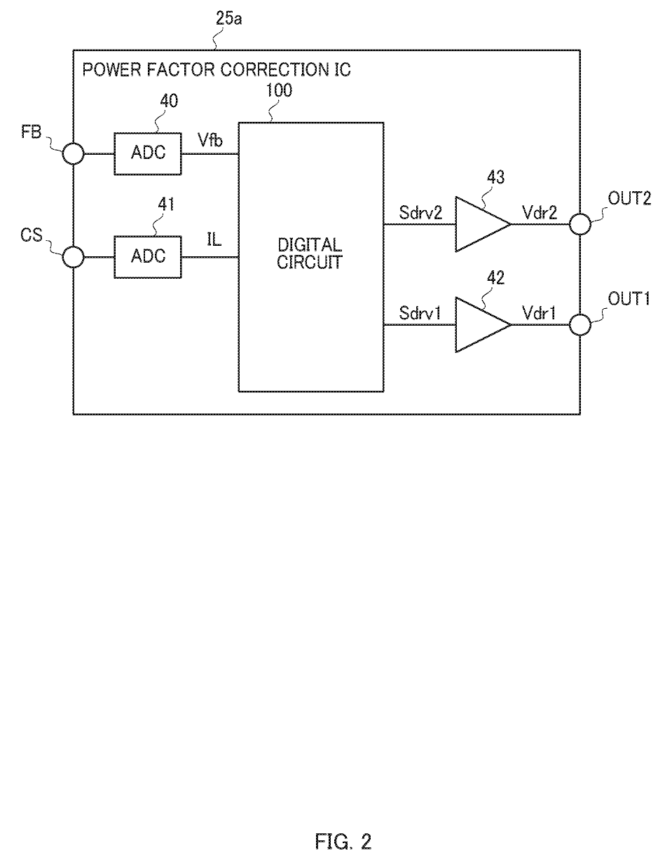

FIG. 2 is a diagram illustrating an example configuration of the power factor correction IC 25a. The power factor correction IC 25a includes analog-to-digital converters (ADCs) 40 and 41, buffer circuits 42 and 43, and a digital circuit 100.

The AD converter 40 converts the feedback voltage Vfb into a digital value, and the AD converter 41 converts a voltage indicating the inductor current IL into a digital value, the voltage having been detected by the resistor 24 and inverted in terms of polarity by a level shifter circuit (not shown). Note that in the present embodiment, the feedback voltage Vfb after the digital value conversion is referred to as the feedback voltage Vfb for convenience, and similarly, a signal indicating the inductor current IL after the digital value conversion and processed in the digital circuit 100 is referred to as the inductor current IL for convenience.

The digital circuit 100 outputs drive signals Sdrv1 and Sdrv2 based on the feedback voltage Vfb and the inductor current IL.

The buffer circuit 42 amplifies the drive signal Sdrv1 and outputs a voltage Vdr1 for driving the NMOS transistor 23.

The buffer circuit 43 amplifies the drive signal Sdrv2 and outputs a voltage Vdr2 for driving the NMOS transistor 26.

### Digital Circuit 100

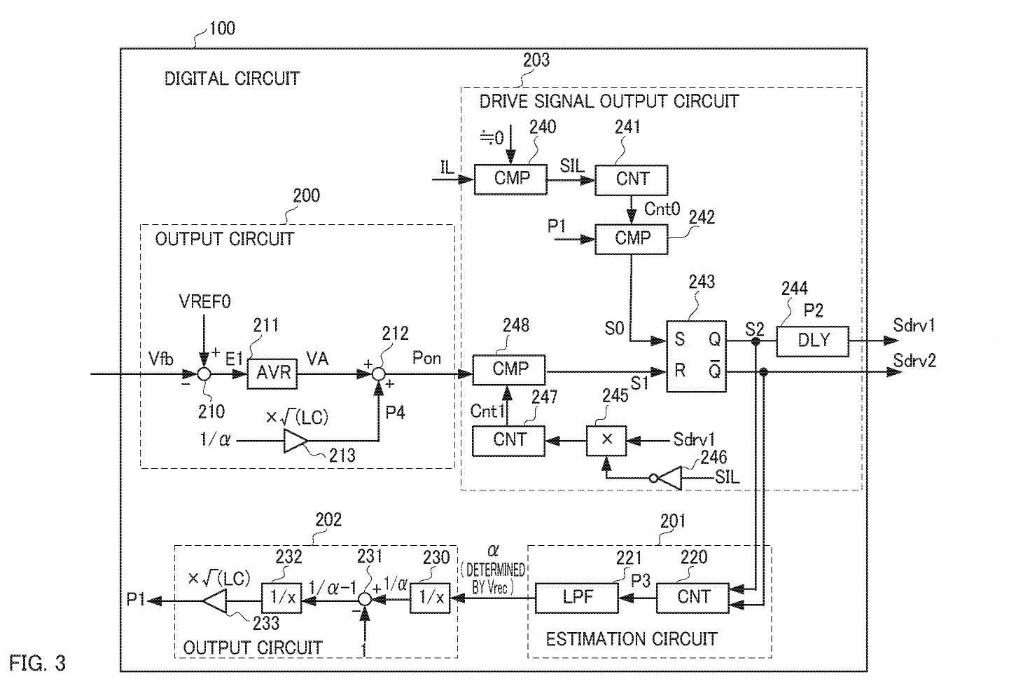

FIG. 3 is a diagram illustrating an example configuration of the digital circuit 100. The digital circuit 100 switches the NMOS transistors 23 and 26 complementarily. The digital circuit 100 outputs the drive signals Sdrv1 and Sdrv2 based on the feedback voltage Vfb and the inductor current IL. The digital circuit 100 corresponds to the "switching control circuit."

Note that hereinbelow, the inductance value of the inductor 22 is denoted as "L," and a capacitance value that combines the capacitance value of the parasitic capacitor Cp1 of the NMOS transistor 23 and the capacitance value of the parasitic capacitor Cp2 of the NMOS transistor 26 is referred to as a "capacitance value C". Although the "capacitance value C" is a capacitance value that combines the NMOS transistors 23 and 26 here, in a case where additional capacitors are provided in parallel to the respective NMOS transistors 23 and 26, the "capacitance value C" is value that also combine the capacitance values of those capacitors as well.

The digital circuit 100 includes output circuits 200 and 202, an estimation circuit 201, and a drive signal output circuit 203.

Based on the feedback voltage Vfb, the output circuit 200 outputs a voltage indicating an ON-period Pon of the NMOS transistor 23. Specifically, the output circuit 200 shortens the ON-period Pon when the feedback voltage Vfb rises and exceeds a reference voltage VREF0 serving as a reference for the output voltage Vout at the target level, whereas the output circuit 200 lengthens the ON-period Pon when the feedback voltage Vfb falls below the reference voltage VREF0. The ON-period Pon corresponds to the "fifth time period."

The output circuit 200 includes a subtractor 210, a voltage regulator (AVR) 211, an adder 212, and an amplifier 213.

The subtractor 210 subtracts the feedback voltage Vfb from the reference voltage VREF0 to calculate an error E1 between the reference voltage VREF0 and the feedback voltage Vfb.

According to the error E1, the voltage regulator 211 outputs a command voltage VA for causing the level of the feedback voltage Vfb to reach the level of the reference voltage VREF0. The subtractor 210 and the voltage regulator 211 correspond to, for example, what is called an error amplifier circuit that performs amplification, integration, or the like on the error E1. The subtractor 210 and the voltage regulator 211 correspond to the "output circuit," and the command voltage VA corresponds to the "ON-period."

The adder 212 adds a voltage indicating a time period P4 from the amplifier 213 described later and the command voltage VA and outputs the sum as a voltage indicating the ON-period Pon.

As a result, the output circuit 200 controls the inductor current IL by outputting the ON-period Pon which is increased or decreased in accordance with rising or falling of the output voltage Vout so as to maintain the output voltage Vout at the target level.

The waveform of the average value of the inductor current IL is thereby similar in shape to the waveform of a rectified voltage Vrec, and the digital circuit 100 corrects the power factor. In other words, the waveform of the averaged input current Iac is similar in shape to that of the AC voltage Vac as well, and the power factor of the AC-DC converter 10 is corrected.

The amplifier 213 outputs a voltage indicating the time period P4 based on the rectified voltage Vrec and a resonant period. Specifically, the amplifier 213 outputs a voltage indicating the time period P4 by amplifying 1/α, which is a reciprocal of a value α from a divider 230 described later, by a factor of √(LC). The value α is determined by the time period from when the NMOS transistor 23 is turned off until when the NMOS transistor 26 is turned off and is further determined by the time period in which the combined capacitance of the parasitic capacitors Cp1 and Cp2 is discharged. √(LC) is a value based on a resonant period 2π√(LC). The amplifier 213 corresponds to the "period arithmetic circuit," and the time period P4 corresponds to the "fourth time period."

The estimation circuit 201 is a circuit configured to estimate the rectified voltage Vrec and outputs the value α based on a time period P3 from when the NMOS transistor 23 is turned off until when the NMOS transistor 26 is turned off. The estimation circuit 201 includes a counter (CNT) 220 and a low-pass filter (LPF) 221.

The counter 220 measures a period from when the Q-output from an SR flip-flop 243 described later reaches a low level (hereinafter referred to as low or low level) until when the Q-bar output goes low. Then, the counter 220 outputs the count resulting as a voltage indicating the time period P3. The time period P3 corresponds to the "third time period."

When the output voltage Vout is maintained at the target level and the ON-period Pon is substantially constant, the larger the phase angle (or the voltage level) of the rectified voltage Vrec is, the larger the peak value of the inductor current IL is, and the smaller the phase angle of the rectified voltage Vrec is, the smaller the peak value of the inductor current IL is.

Then, the time period, from when the NMOS transistor 23 is turned off until when the inductor current IL stops flowing, is longer as the phase angle of the rectified voltage Vrec becomes larger and is shorter as the phase angle of the rectified voltage Vrec becomes smaller. Thus, in a case where the AC-DC converter 10 operates in the critical mode, the time period P3 is longer as the phase angle of the rectified voltage Vrec becomes larger and is shorter as the phase angle of the rectified voltage Vrec becomes smaller. As a result, the time period P3 is a time period based on an AC component (or voltage level) of the rectified voltage Vrec.

What is meant by the phase angle of the rectified voltage Vrec being "large" is that an angle expressed as the phase angle of the AC voltage Vac is in a range of, for example, 90±10 + 180n degrees, i.e., (80 to 100) + 180n degrees. Meanwhile, what is meant by the phase angle of the rectified voltage Vrec being "small" is that the phase angle is in a range of, for example, 0±10 + 180n degrees, i.e., (-10 to +10) + 180n degrees. Note that n is an integer.

The low-pass filter 221 integrates the voltage according to the time period P3 and outputs the value α. Thus, the value α is the rectified voltage Vrec estimated based on the time period P3.

Based on the estimated rectified voltage Vrec, the resonant frequency, and the output voltage Vout, the output circuit 202 outputs a voltage indicating a time period P1 described later. The output circuit 202 includes the divider 230, a divider 232, a subtractor 231, and an amplifier 233. The output circuit 202 corresponds to the "period output circuit."

The divider 230 computes the reciprocal of the value α and outputs a voltage indicating 1/α.

The subtractor 231 subtracts 1 from 1/α and outputs a voltage indicating 1/α - 1.

The divider 232 computes the reciprocal of 1/α- 1 and outputs a voltage indicating 1/(1/α- 1).

The amplifier 233 amplifies 1/(1/α- 1) by a factor of √(LC) and outputs it as a voltage indicating the time period P1. As will be described in detail later, the time period P1 is a time period in which the inductor current IL changes from a predetermined value (e.g., zero ampere) to a current value I0 smaller than the predetermined value, with the NMOS transistor 23 being off and the NMOS transistor 26 being on. The output circuit 202 may output the time period P1 further using the time period in which the parasitic capacitor Cp1 is discharged. The time period P1 corresponds to the "first time period," and the current value I0 corresponds to the "first value."

Based on the inductor current IL, the ON-period Pon, and the time period P1, the drive signal output circuit 203 outputs the drive signal Sdrv1 for switching the NMOS transistor 23 and the drive signal Sdrv2 for switching the NMOS transistor 26. The drive signal Sdrv1 corresponds to the "first drive signal," and the drive signal Sdrv2 corresponds to the "second drive signal."

The drive signal output circuit 203 includes comparators (CMP) 240, 242, and 248, counters 241 and 247, the SR flip-flop 243, a delay circuit (DLY) 244, a multiplier 245, and a NOT circuit 246.

The comparator 240 detects that the inductor current IL falls below the predetermined value. Specifically, the comparator 240 outputs a signal SIL at a high level (hereinafter referred to as high or high level) once the inductor current IL falls below the predetermined value (e.g., substantially zero), whereas the comparator 240 outputs a low signal SIL when the inductor current IL is larger than the predetermined value.

The counter 241 measures a time period during which the high signal SIL is inputted and outputs a voltage indicating a count value Cnt0. The counter 241 is reset upon input of the low signal SIL.

The comparator 242 determines magnitude relation between the voltage indicating the count value Cnt0 and the voltage indicating the time period P1. The comparator 242 outputs a high signal S0 when the count value Cnt0 is larger than the time period P1 and outputs a low signal S0 when the count value Cnt0 is smaller than the time period P1. Accordingly, as will be described later, in response to the time period P1 since the inductor current has reached the predetermined value with the NMOS transistor 23 turned off, the drive signal output circuit 203 outputs the drive signal Sdrv2 to turn off the NMOS transistor 26.

The SR flip-flop 243 outputs a signal S2 and the drive signal Sdrv2 based on the signal S0 from the comparator 242 and a signal S1 from the comparator 248 described later. Specifically, when the comparator 242 outputs a high signal S0, the SR flip-flop 243 outputs a high signal S2 and a low drive signal Sdrv2.

On the other hand, when the comparator 248 outputs a high signal S1, the SR flip-flop 243 outputs a low signal S2 and a high drive signal Sdrv2.

Note that when the comparators 242 and 248 both output low signals S0 and S1, the SR flip-flop 243 does not change the logic level of the signal S2 and the drive signal Sdrv2. Although the SR flip-flop 243 outputs a low signal S2 and a high drive signal Sdrv2 simultaneously above, a dead time may be provided. In this case, after outputting the low signal S2, the SR flip-flop 243 outputs the high drive signal Sdrv2 after a lapse of the dead time.

The delay circuit 244 delays a high signal S2 by a time period P2 and outputs the high signal S2 as the drive signal Sdrv1. On the other hand, upon input of a low signal S2, the delay circuit 244 outputs a low drive signal Sdrv1 without delaying the signal S2. Thus, the drive signal output circuit 203 outputs the drive signal Sdrv1 to turn on the NMOS transistor 23 in response to the time period P2 after the time period P1, since the inductor current has reached the predetermined value with the NMOS transistor 23 turned off. The time period P2 corresponds to the discharge period of the parasitic capacitors Cp1 and Cp2 and is determined based on the resonant period of the parasitic capacitor Cp1 and the inductor 22. The time period P2 corresponds to the "second time period."

The multiplier 245 multiplies the drive signal Sdrv1 by the signal obtained by the NOT circuit 246 inverting the signal SIL and outputs the result to the counter 247. Specifically, the multiplier 245 resets the counter 247 and stops the operation when the signal SIL is high, i.e., when the inductor current IL is smaller than the predetermined value.

On the other hand, when the signal SIL is low, i.e., the inductor current IL is larger than the predetermined value, the multiplier 245 causes the counter 247 to measure a time period during which the drive signal Sdrv1 is high.

When the inductor current IL is larger than the predetermined value, the counter 247 measures the time period during which the drive signal Sdrv1 is high and outputs the measured time period as a voltage indicating a count value Cnt1. On the other hand, when the inductor current IL is smaller than the predetermined value, the counter 247 is reset and does not operate.

The comparator 248 determines magnitude relation between the voltage indicating the count value Cnt1 and the voltage indicating the ON-period Pon. The comparator 248 outputs a high signal S1 when the count value Cnt1 is larger than the ON-period Pon, and outputs a low signal S1 when the count value Cnt1 is smaller than the ON-period Pon. Thus, the drive signal output circuit 203 outputs the drive signal Sdrv1 to turn off the NMOS transistor in response to the ON-period Pon, since the inductor current has reached the predetermined value after the NMOS transistor 23 is turned on.

### Operation of the Power Factor Correction IC 25a and Time Periods P1, P2, and Pon

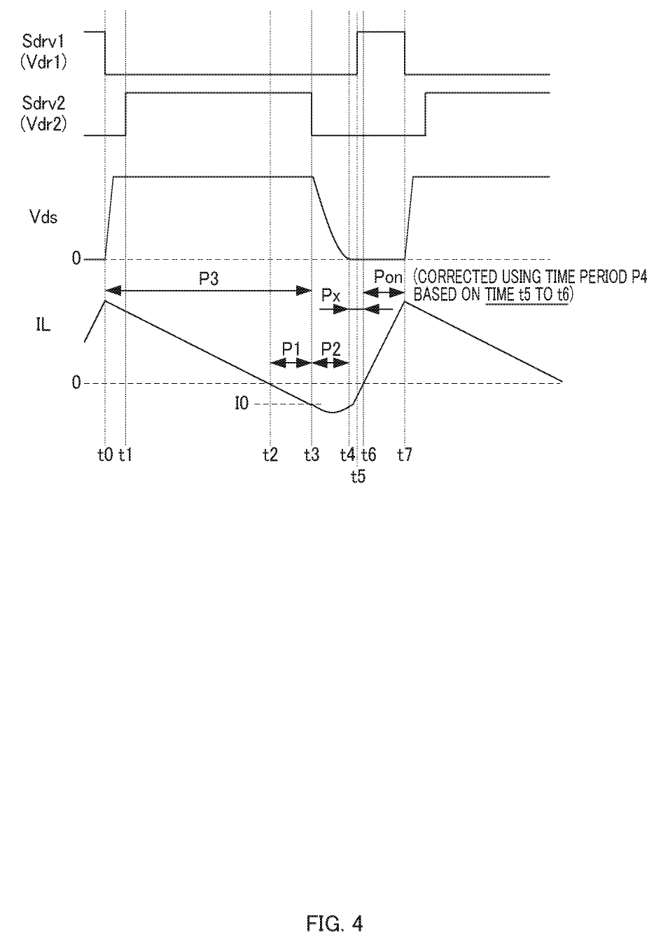

FIG. 4 is a diagram illustrating an example operation of the power factor correction IC 25a. The following describes the time periods P1, P2, and Pon as well as the operation of the power factor correction IC 25a.

At time t0, the delay circuit 244 outputs a low drive signal Sdrv1 and turns off the NMOS transistor 23. Since the NMOS transistor 23 is turned off, the current value of the inductor current IL flowing in the positive direction starts decreasing. Further, since the parasitic diode Dp2 of the NMOS transistor 26 in FIG. 1 is on, a voltage Vds increases to a voltage close to the output voltage Vout.

At time t1 at which a dead time has elapsed since time t0, the SR flip-flop 243 outputs a high drive signal Sdrv2 and turns on the NMOS transistor 26. Accordingly, the inductor current IL flows through the capacitor 27 via the NMOS transistor 26 instead of flowing via the parasitic diode Dp2.

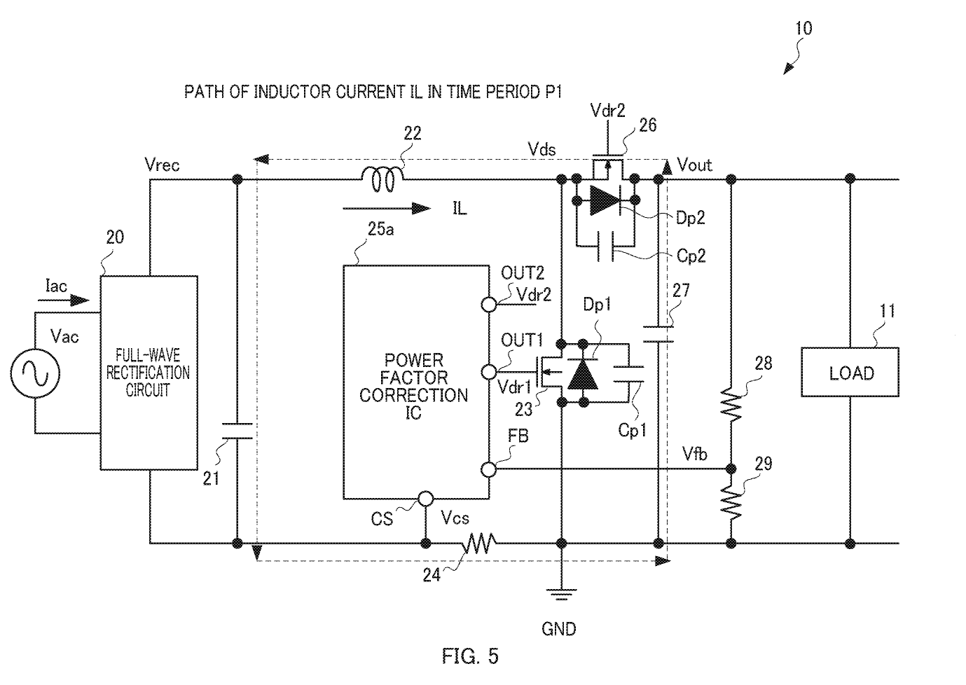

At time t2, the inductor current IL reaches the predetermined value. The comparator 240 outputs a high signal SIL, and the counter 241 starts counting. Thereafter, the inductor current IL flows in the negative direction. Specifically, in the time period P1 which starts at time t2, since the output voltage Vout generated at the capacitor 27 has a higher voltage level than the rectified voltage Vrec, the inductor current IL flows from the capacitor 27 to the inductor 22 via the NMOS transistor 26 and flows through the capacitor 27 via the capacitor 21, as shown in FIG. 5.

At time t3 at which the time period P1 has elapsed since time t2, the voltage indicating the count value Cnt0 of the counter 241 is larger than the voltage indicating the time period P1; therefore, the comparator 242 outputs a high signal S0, and the SR flip-flop 243 outputs a high signal S2 and a low drive signal Sdrv2. Then, the NMOS transistor 26 is turned off. Thereafter, the voltage Vds starts decreasing.

The time period P1 is a time period in which, after the time t2, the inductor current IL flows in the negative direction and the current value reaches the negative current value I0. Then, the current value I0 is substantially a value obtained by -√(C/L) × Vrec. Further, the time period P1 changes according to the voltage level of the rectified voltage Vrec, i.e., according to the value α. Specifically, the time period P1 is computed to a time period obtained by √(LC)/(1/α- 1).

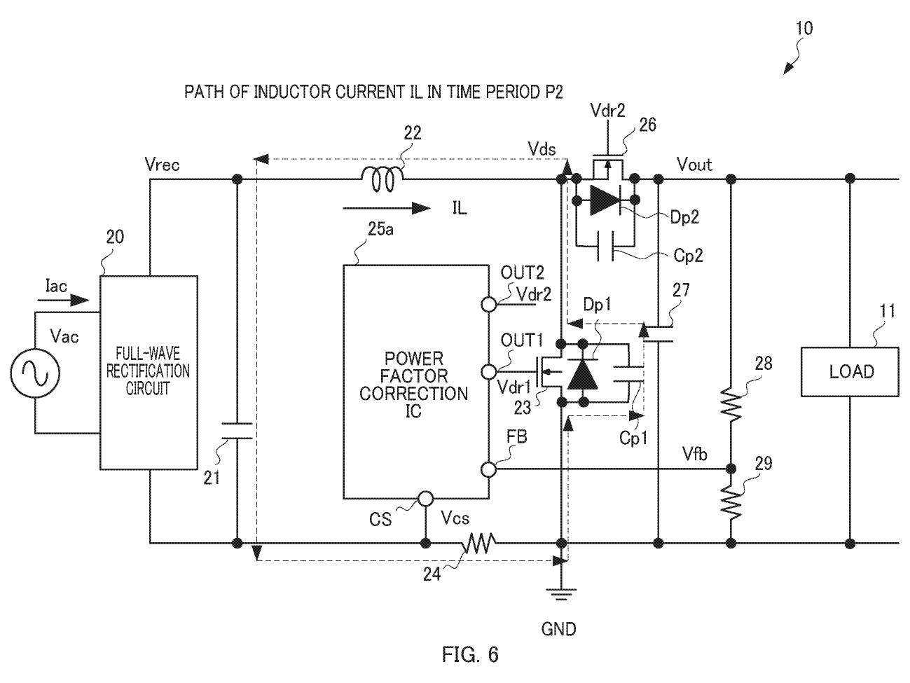

In the time period P2 which starts at time t3, the NMOS transistor 26 is turned off, but the inductor 22 tends to keep passing the inductor current IL in the negative direction. Thus, as shown in FIG. 6, the inductor current IL flows from the parasitic capacitor Cp1 to the parasitic capacitor Cp1 via the inductor 22 and the capacitor 21. The time period from time t0 to time t3 is the time period P3.

At time t4 at which the time period P2 has elapsed since time t3, the voltage Vds decreases to close to a predetermined level (e.g., zero voltage). Thereafter, the delay circuit 244 outputs a high drive signal Sdrv1 to turn on the NMOS transistor 23, and the switching loss of the NMOS transistor 23 is reduced irrespective of the voltage level of the rectified voltage Vrec.

The time period P2 is a time period in which the voltage Vds decreases because the parasitic capacitor Cp1 discharges with the NMOS transistors 23 and 26 both being off. Further, the time period P2 is a predetermined time period irrespective of the voltage level of the rectified voltage Vrec. Specifically, the time period P2 is √(LC).

At time t5, the delay circuit 244 outputs a high drive signal Sdrv1, turning on the NMOS transistor 23. Since the NMOS transistor 23 is turned on when the voltage Vds is close to zero voltage, zero-voltage switching (ZVS) is achieved.

At time t6, the inductor current IL exceeds the predetermined value. Thus, the counter 247 measures the time period during which the delay circuit 244 outputs a high drive signal Sdrv1.

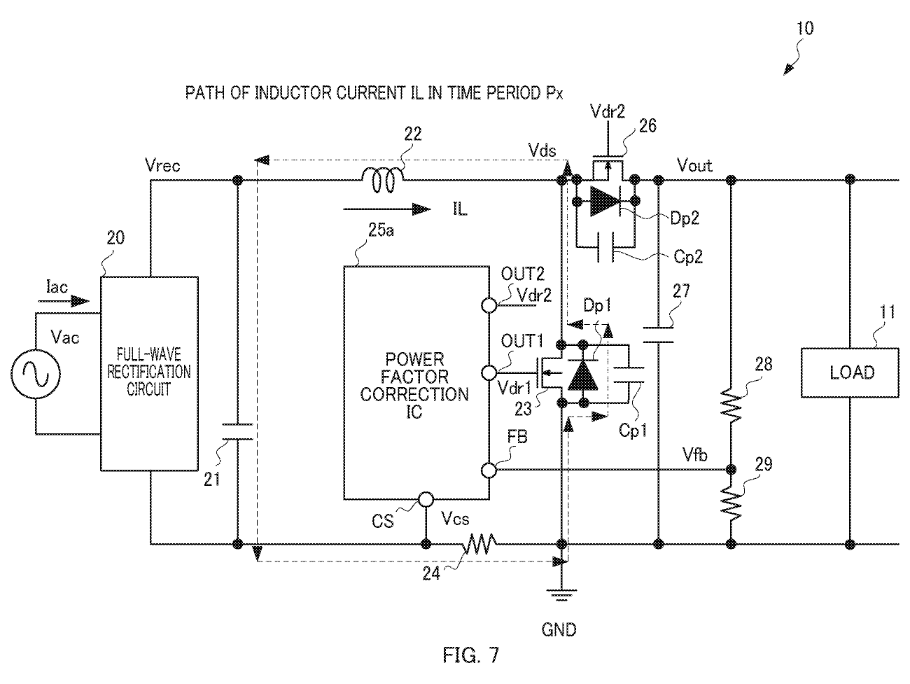

In a time period Px from time t4 to time t6, the parasitic diode Dp1 of the NMOS transistor 23 is turned on, and as shown in FIG. 7, the NMOS transistor 23 operates in reverse conduction. When the NMOS transistor 23 is turned on in this time period Px, ZVS is achieved, and conduction loss is reduced.

At time t7 at which the ON-period Pon has elapsed since time t6, the count value Cnt1 of the counter 247 exceeds the ON-period Pon, and thus, the comparator 248 outputs a high signal S1. Then, the SR flip-flop 243 outputs a low signal S2, and the delay circuit 244 outputs a low drive signal Sdrv1. Thereafter, the same operation is repeated.

The ON-period Pon is computed as a voltage obtained by adding the command voltage VA determined by the output voltage Vout and the voltage indicating the time period P4. The time period P4 is a time period for compensating for a substantial decrease in the ON-period caused by the inductor current flowing in the negative direction in the time period from when the NMOS transistor 23 is turned on until when the inductor current IL reaches the predetermined value (i.e., the time period from time t5 to time t6). Specifically, the time period P4 is a period obtained by √(LC)/α. The ON-period Pon is thus corrected by the time period P4 that is based on times t5to t6.

Then, using the ON-period Pon which is longer than the ON-period Pon determined only by the command voltage VA cancels out the influence of the time period (e.g., times t5 to t6) in which the inductor current IL flows in the negative direction and in which it is deemed that the NMOS transistor 23 is not actually on. Consequently, the average value of the inductor current IL matches with the AC component of the rectified voltage Vrec, and also, the output voltage Vout is more likely to be maintained at the target level.

Thus, a switching control circuit capable of reducing switching loss can be provided.

### Simulation Results

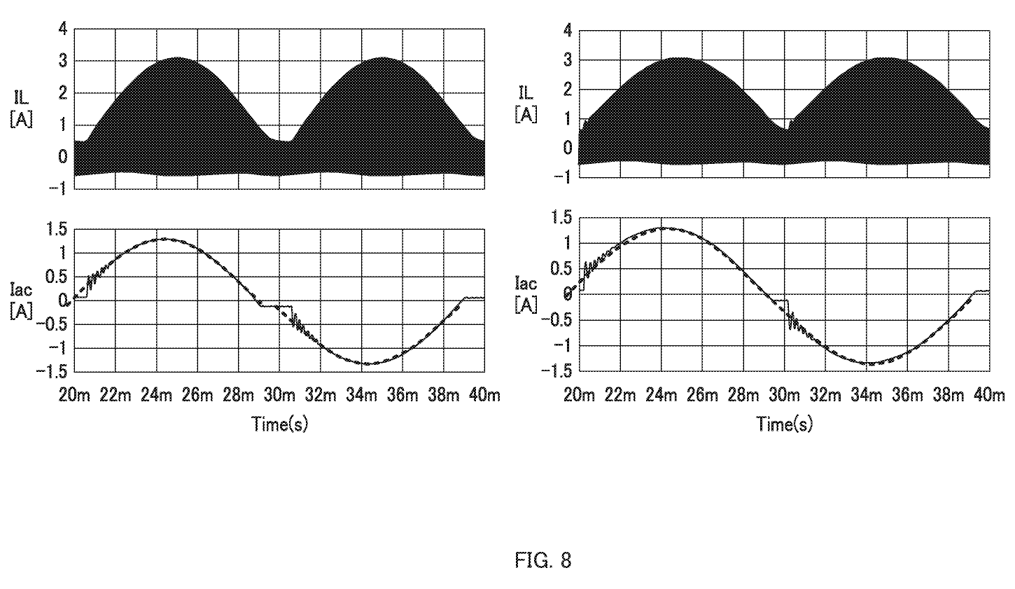

FIG. 8 is a diagram illustrating examples of simulation results. FIG. 8 shows four sets of simulation results, with two of them on the left illustrating simulation results performed in cases with the ON-period Pon fixed and two of them on the right illustrating simulation results performed in cases with the ON-period Pon corrected based on the time period P4. In the lower two sets of simulation results, a solid line represents the averaged input current Iac, and a dashed line represents a sinusoidal wave.

When the ON-period Pon is a fixed value, if the envelope of a negative current (a current flowing in the negative direction) as the inductor current IL is in a sine waveform, so is the envelope of a positive current (a current flowing in the positive direction); thus, the input current Iac is in a sine waveform as well.

However, in actuality, due to the influence of the current discharging the combined capacitance of the parasitic capacitors Cp1 and Cp2 (the capacitance value C), the input current Iac does not become a sine waveform, as illustrated in the lower left simulation results. Further, in a range with a small phase angle, the average value of pulse current generated by switching of the NMOS transistor 23 (i.e., the input current Iac) decreases more significantly.

Accordingly, a sinusoidal component of the positive half-wave and a sinusoidal component of the negative half-wave both decrease in absolute value and do not match in the range with a small phase angle (e.g., 180°). Thus, the input current Iac has a waveform with a step.

On the other hand, if the ON-period Pon is corrected based on the time period P4, the amount of the decrease of the current (influence of the inductor current in the negative direction) is compensated for. Thus, as illustrated in the lower right simulation results, a sinusoidal component of the positive half-wave and a sinusoidal component of the negative half-wave do not have a step between them and match in the range with a small phase angle (e.g., 180°). A waveform combining them forms a continuous one cycle of a sine wave.

In a comparison between the lower left simulation results and the lower right simulation results, in the simulation results on the left, the input current Iac is deviated from a sine waveform in the vicinities of 30 milliseconds. On the other hand, according to the simulation results on the right, the input current Iac flows along a sine waveform except in a time period in which the diode is turned off in the full-wave rectifier circuit 20. Thus, the power factor correction IC 25a can reduce distortion of the input current Iac by correcting the ON-period Pon based on the time period P4.

### Modification

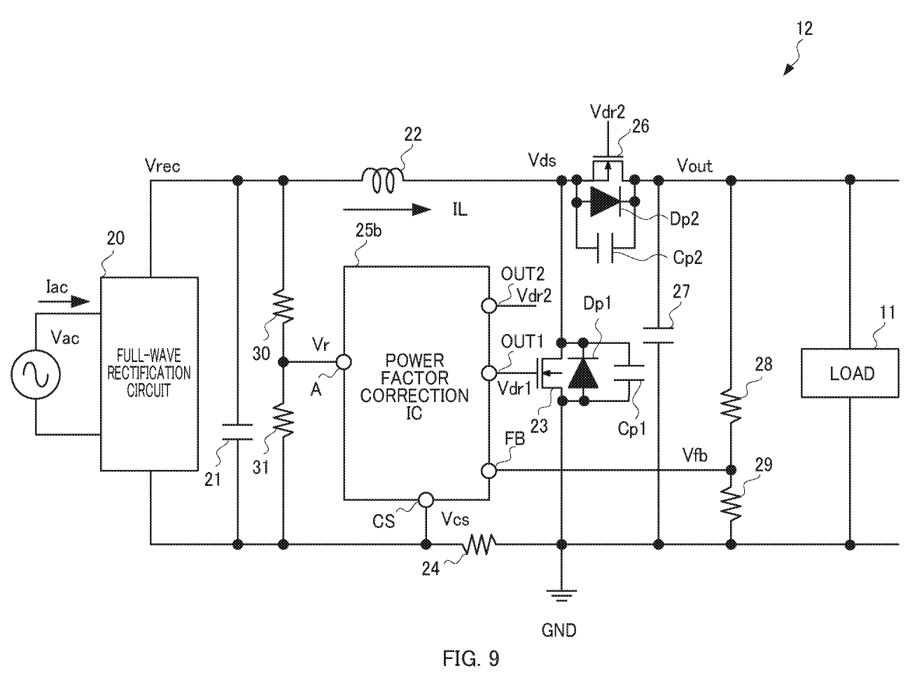

FIG. 9 is a diagram illustrating an example configuration of an AC-DC converter 12. The AC-DC converter 12 is the same as the AC-DC converter 10 except that the AC-DC converter 12 is provided with resistors 30 and 31 configured to divide the rectified voltage Vrec and that a power factor correction IC 25b is provided with a terminal A.

The AC-DC converter 12 includes the full-wave rectifier circuit 20, the capacitors 21 and 27, the inductor 22, the NMOS transistors 23 and 26, the resistors 24, 30, and 31, and the power factor correction IC 25b.

The resistors 30 and 31 configure a voltage divider circuit configured to divide the rectified voltage Vrec and generate a voltage Vr at the point of connection. The voltage Vr is then applied to the terminal A of the power factor correction IC 25b.

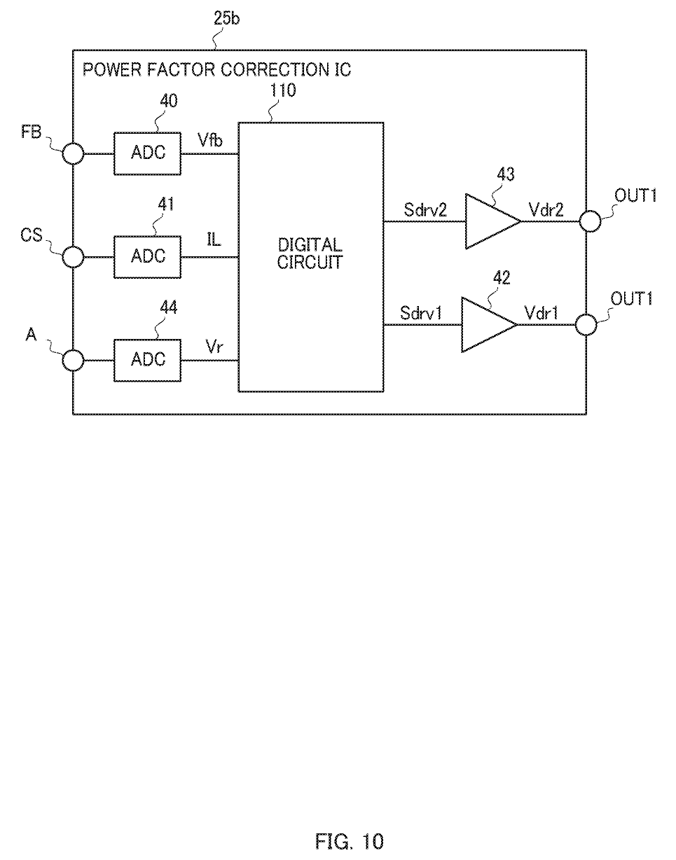

FIG. 10 is a diagram illustrating an example configuration of the power factor correction IC 25b. The power factor correction IC 25b includes analog-to-digital converters (ADCs) 40, 41, and 44, the buffer circuits 42 and 43, and a digital circuit 110. The AD converter 44 converts the voltage Vr to a digital value.

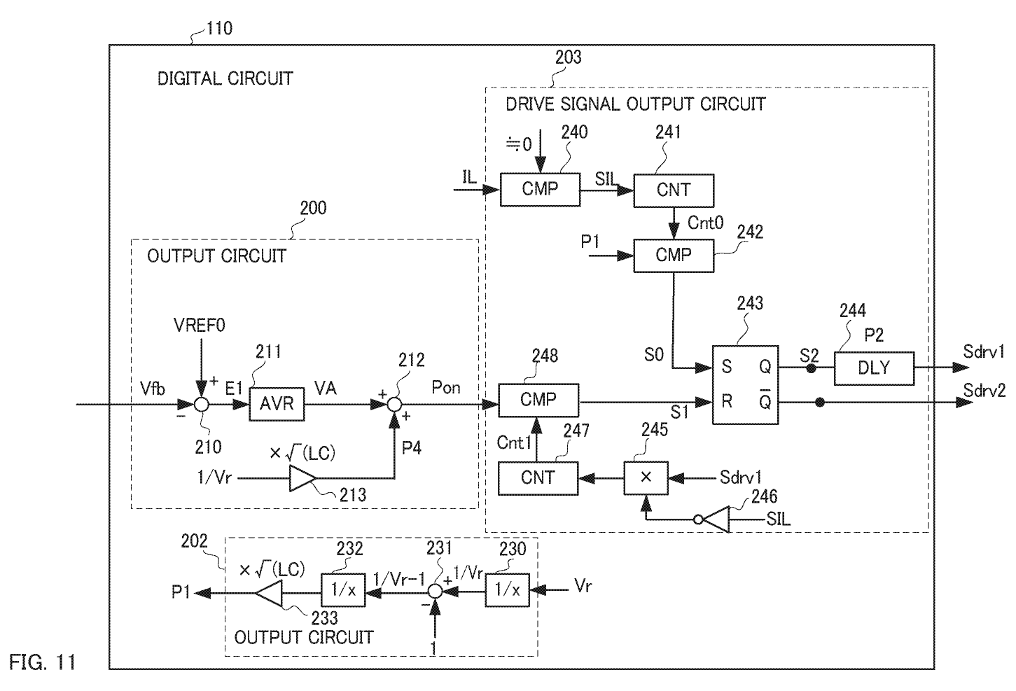

FIG. 11 is a diagram illustrating an example configuration of the digital circuit 110. The digital circuit 110 includes the output circuits 200 and 202 and the drive signal output circuit 203.

The output circuit 202 may output the voltage Vr indicating the time period P1 based on the voltage Vr according to the detected rectified voltage Vrec, the resonant period, and the output voltage Vout. In this way, a switching control circuit capable of reducing switching loss can be provided also by dividing the rectified voltage Vrec with the resistors 30 and 31 and detecting the voltage Vr.

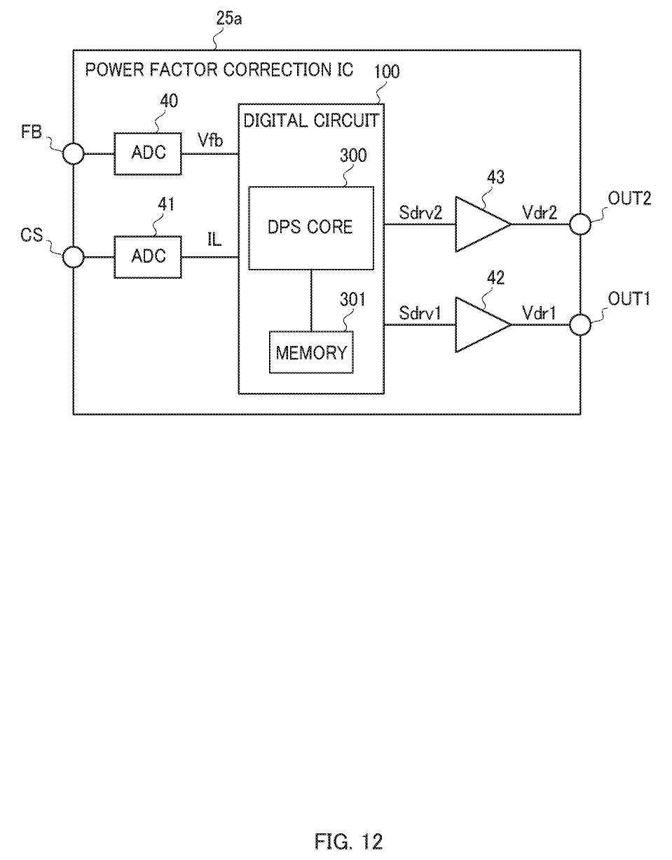

FIG. 12 is a diagram illustrating an example embodiment using a digital signal processor (DPS). The digital circuit 100 includes a DSP core 300 and memory 301 storing programs executed by the DSP core 300 and various kinds of information. By executing a program, the DSP core 300 causes the digital circuit 100 to implement various circuits and functional blocks such as an adder, a subtractor, a multiplier, a divider, a filter, and an amplifier circuit. The same is also true for the digital circuit 110.

Further, the digital circuits 100 and 110 may be implemented not by the DSP core 300 and the memory 301, but by a hardware logic circuit (i.e., a wired logic). Further, a wired logic and a programmable logic may coexist.

In a case where the DSP core 300 executes a program, the output circuit 200 corresponds to an output part 200, the estimation circuit 201 corresponds to an estimation part 201, the output circuit 202 corresponds to an output part 202, and the drive signal output circuit 203 corresponds to a drive signal output part 203.

### Summary

The AC-DC converter 10 of the present embodiment has thus been described above. The digital circuit 100 includes the output circuit 202 and the drive signal output circuit 203. Thus, a switching control circuit capable of reducing switching loss can be provided.

The output circuit 202 outputs the time period P1 based on the estimated rectified voltage Vrec, the resonant period 2π√(LC), and the output voltage Vout. Thus, the digital circuit 100 can output the time period P1 using the estimated rectified voltage Vrec without using a voltage divider circuit for detecting a rectified voltage.

The output circuit 202 outputs the time period P1 further using a discharge period of the parasitic capacitor Cp1. This makes it possible to output the time period P1 more accurately.

The digital circuit 100 includes the estimation circuit 201. This makes it possible to estimate the rectified voltage Vrec based on the time period P3 without detecting the rectified voltage Vrec.

The digital circuit 110 causes the output circuit 202 to output the time period P1 based on the voltage Vr according to the detected rectified voltage Vrec, the resonant period 2π√(LC), and the output voltage Vout. This makes it possible for the output circuit 202 to output the time period P1 even with the detected rectified voltage Vrec in a similar manner to a case with the estimated rectified voltage Vrec.

The output circuit 200 includes the subtractor 210, the voltage regulator 211, the adder 212, and the amplifier 213. Thus, it is possible to reduce the influence on the power factor by the time period in which the inductor current is flowing in the negative direction while the NMOS transistor 23 is on.

The digital circuit 100 can be suitably used for the AC-DC converter 10.

The present invention has been made in view of problems in prior art described earlier and aims to provide a switching control circuit capable of reducing switching loss.

The present invention can provide a switching control circuit capable of reducing switching loss.

Embodiment(s) of the present disclosure described above is/are simply to facilitate understanding of the present disclosure and is/are not in any way to be construed as limiting the present disclosure. The present disclosure may variously be changed or altered without departing from its essential features and encompass equivalents thereof.

What is claimed is:

1. A switching control circuit for a power supply circuit that generates, for an output capacitor, an output voltage at a target level from an alternating current (AC) voltage inputted to the power supply circuit, the power supply circuit including
an inductor configured to receive a rectified voltage corresponding to the AC voltage,
a first transistor configured to control an inductor current flowing through the inductor, the first transistor having a parasitic capacitor, and
a second transistor provided between the inductor and the output capacitor,
the switching control circuit being configured to complementarily switch the first transistor and the second transistor, the switching control circuit comprising:
a time period output circuit configured to output a first time period in which the inductor current changes from a predetermined value to a first value smaller than the predetermined value, with the first transistor being off and the second transistor being on; and
a drive signal output circuit configured to output a first drive signal to switch the first transistor and a second drive signal to switch the second transistor,
the drive signal output circuit being configured to
output the second drive signal to turn off the second transistor, in response to the first time period having elapsed since the inductor current has reached the predetermined value with the first transistor being off, and
output the first drive signal to turn on the first transistor, in response to a second time period having elapsed after the lapse of the first time period, and
the second time period being determined based on a resonant period of the parasitic capacitor of the first transistor and the inductor, and being a time period in which a voltage level of an output electrode of the first transistor drops to a predetermined level.

2. The switching control circuit according to claim 1, wherein
the time period output circuit outputs the first time period, based on an estimated rectified voltage, the resonant period, and the output voltage.

3. The switching control circuit according to claim 2, wherein
the time period output circuit outputs the first time period based further on a discharge period of the parasitic capacitor.

4. The switching control circuit according to claim 2, further comprising:
an estimation circuit configured to estimate the rectified voltage, based on a third time period from when the first transistor is turned off until when the second transistor is turned off, to thereby generate the estimated rectified voltage.

5. The switching control circuit according to claim 1, wherein
the time period output circuit outputs the first time period, based on the rectified voltage, the resonant period, and the output voltage.

6. The switching control circuit according to claim 1, further comprising:
an output circuit configured to output an ON-period for turning on the first transistor, based on the output voltage;
a time period arithmetic circuit configured to calculate a fourth time period, based on the rectified voltage and the resonant period; and
an adder configured to output a fifth time period obtained by adding the ON-period and the fourth time period, wherein
the drive signal output circuit outputs the first drive signal to turn off the first transistor, in response to the fifth time period having elapsed since the inductor current has reached the predetermined value after the first transistor is turned on.

7. A power supply circuit configured to generate, for an output capacitor, an output voltage at a target level from an alternating current (AC) voltage inputted to the power supply circuit, the power supply circuit comprising:
an inductor configured to receive a rectified voltage corresponding to the AC voltage;
a first transistor configured to control an inductor current flowing through the inductor, the first transistor having a parasitic capacitor;
a second transistor provided between the inductor and the output capacitor; and
a switching control circuit configured to complementarily switch the first transistor and the second transistor, the switching control circuit including
a time period output circuit configured to output a first time period from when the inductor current changes from a predetermined value to a first value smaller than the predetermined value, with the first transistor off and the second transistor on, and
a drive signal output circuit configured to output a first drive signal to switch the first transistor, and a second drive signal to switch the second transistor,
the drive signal output circuit being configured to
output the second drive signal to turn off the second transistor, in response to the first time period having elapsed since the inductor current has reached the predetermined value with the first transistor being off, and
output the first drive signal to turn on the first transistor, in response to a second time period having elapsed after the lapse of the first time period, and
the second time period being determined based on a resonant period of the parasitic capacitor of the first transistor and the inductor, and being a period in which a voltage level of an output electrode of the first transistor drops to a predetermined level.
